(19) United States
(12) Patent Application Publication
(10) Pub. No.: US 2016/0058028 A1
(43) Pub. Date: Mar. 3, 2016

(54) ENHANCEMENT OF COFFEE QUALITY AND FLAVOR BY USING PICHIA KLUYVERI YEAST STARTER CULTURE FOR COFFEE FERMENTATION

(71) Applicant: CHR. HANSEN A/S, Hoersholm (DK)

(72) Inventors: Sofie SAERENS, Skovlunde (DK); Jan Hendrik SWIEGERS, Fredensborg (DK)

(73) Assignee: Chr. Hansen A/S, Hoersholm, Denmark (DK)

(21) Appl. No.: 14/888,552

(22) PCT Filed: May 1, 2014
(86) PCT No.: PCT/EP2014/058939

§ 371 Date: Nov. 2, 2015

(30) Foreign Application Priority Data
May 3, 2013 (EP) 13166386.6

(51) Int. Cl. A23F 5/02; A23L 1/20

(52) U.S. Cl. CPC A23F 5/02; A23L 1/2008

(57) ABSTRACT

A method of fermenting coffee beans with a Pichia yeast strain.

### FIELD OF THE INVENTION

The present invention relates to the field of coffee fermentation. Specifically, the invention relates to a method of fermenting coffee beans with a Pichia yeast strain.

### BACKGROUND OF THE INVENTION

Coffee is a brewed beverage with a distinct aroma and flavor, prepared from the roasted seeds/beans of the Coffea plant.

A coffee bean is a seed of the coffee plant, and is the source for coffee. It is the pit inside the red or purple fruit often referred to as a cherry. Even though they are seeds, they are often referred to as ‘beans’ because of their resemblance to true beans.

Herein may the terms coffee bean and coffee seed be used interchangeably.

The term coffee cherry is in the art sometimes referred to as coffee berry and the skilled person understands that in the present context may these terms be used interchangeably—accordingly, herein may the terms coffee cherry (or coffee cherries) and coffee berry (or coffee berries) be used interchangeably.

Coffea plant is a member of the Rubiaceae family.

Several species of Coffea may be grown for the beans. Coffea arabica accounts for 75-80 percent of the world's coffee production, while Coffea canephora accounts for about 20 percent.

When the fruit is ripe, it is many times handpicked, using either “selective picking”, where only the ripe fruit is removed, or “strip-picking”, where all of the fruit is removed from a branch all at once. Because a tree can have both ripe and unripe berries at the same time, one area of crop has to be picked several times, making harvesting the most labor intensive process of coffee bean production.

There are different methods of processing the coffee berries.

One method is “wet processing”. The flesh/skin of the berries is separated from the seeds and then the seeds are fermented—soaked in water for e.g. about two days. This dissolves essentially any pulp or sticky residue that may still be attached to the seeds. They are then washed and dried in e.g. the sun, or, in the case of commercial manufacturers, in drying machines.

The “dry processing” method is cheaper and simpler, used e.g. for lower quality seeds. Twigs and other foreign objects are separated from the berries and the fruit is then spread out in the sun on e.g. concrete or brick for e.g. 2-3 weeks (where fermentation occurs), turned regularly for even drying. The dried pulp is removed from the seeds afterward.

As understood by the skilled person in the present context—depending on the processing method used for making the coffee (e.g. “wet processing” or “dry processing”) there may be removed more or less flesh/skin of the berries/cherries before start of the actual fermentation process. According to the art and as understood by the skilled person in the present context—this fact may be expressed as there for the herein relevant coffee fermentation process is used a plant material consisting essentially of coffee berries/beans.

After processing has taken place, the husks are removed and the seeds are roasted, which gives them their varying brown color, and they can then be sorted for bagging.

The article of Silva et al (Succession of bacterial and fungal communities during natural coffee (Coffea arabica) fermentation, Food microbiology, vol. 25, December 2008, pages 951-957) describes presence of different yeast species such as e.g. Pichia anomala and Pichia guilliermondii during fermentation of coffee (Pichia kluyveri is not mentioned in the article—see e.g. Table 2 on page 954). The coffee cherries were hand-picked at the mature stage (see page 952, section “2.1 Sampling”). In FIG. 1 on page 953 is shown the frequency of filamentous fungi, yeast and bacteria throughout the fermentation of coffee and at time zero is the frequency of filamentous fungi and yeast virtually identical and low. On page 953, right column, last paragraph is said that “filamentous fungi species were present at approximately 10² CFU/ml until the 8th fermentation and drying day”. Accordingly, the hand-picked cherries of the Silva et al article comprised less than 10² CFU/ml of Pichia species.

The article of Wafa Masoud et al (Yeast involved in fermentation of Coffea arabica in East Africa determined by genotyping and by direct denaturating gradient gel electrophoresis, Yeast, vol. 21, May 2004, pages 549-556) describes presence of different yeast species such as e.g. Pichia kluyveri during fermentation of coffee. Page 550, section “Coffee samples” explains that the “Samples of Coffea arabica were collected during different stages of the wet processing method from two processing sites in Arusha, Tanzania (Table I)”. Accordingly, contrary to above discussed article of Silva et al—in the article of Wafa Masoud were the cherries not hand-picked cherries, but were collected on the actual coffee processing sites in Tanzania. As known in the art, a coffee processing site already comprises numerous different microorganism species (e.g. yeast species) from earlier made coffee production. In Table I on page 550 it is said that fresh beans samples comprised 6×10⁵ CFU/g of Pichia kluyveri. Compared to the hand-picked cherries of the Silva et al article this may be seen as a relatively high number of Pichia kluyveri. A possible explanation of this difference may be that the so-called fresh bean samples collected at the processing sites in Tanzania had been “contaminated” with other Pichia kluyveri strains present at the processing sites due to earlier made coffee production at the processing sites.

The Silva et al and Wafa Masoud et al articles do not disclose the artificial addition of Pichia yeast strains prior to fermenting coffee.

EP1695631A1 (Suntory Limited) discloses artificial addition of so-called yeast for wine fermentation strains (termed L2323 CK S102 strains) in order to produce more flavored coffee beans (see e.g. Table 2 on page 10).

In EP1695631A1 is not described anything of herein relevance with respect to a possible dose effect of the so-called yeast for wine fermentation strains—i.e. there is no teaching relating to if more of the so-called yeast for wine fermentation strains would have been added then the coffee beans would have comprised more flavor.

### SUMMARY OF THE INVENTION

The problem to be solved by the present invention relates to the provision of a method for fermentation of coffee berries/beans wherein the presence of desirable flavor compounds, such as isoamyl acetate, is enhanced and the overall quality of the fermentation is improved.

The solution is based on the findings by the present inventors that by inoculation of the coffee berries/beans with a Pichia (e.g. Pichia kluyveri) yeast strain one are able to produce fermented roasted coffee beans with an increased flavor profile.

Further and as shown in Example 2 herein, the present inventors identified a dose effect—i.e. when more Pichia was added then the coffee beans comprised more isoamyl acetate (a compound that gives a more fruity flavor/taste).

Without being limited theory—it is submitted that this dose effect was not obvious for the skilled person in view of the art. For instance, above discussed prior art articles describe that naturally fermented coffee (i.e. without addition of extra Pichia as described herein) already comprises Pichia and skilled person could prima facie believe that this natural amount of Pichia yeast was sufficient to induce the maximum amount of isoamyl acetate in the coffee.

Therefore is was surprising to the present inventors that incremental increases in amount of Pichia added resulted in corresponding incremental increases in isoamyl acetate.

The results of working Example 1 herein demonstrate that roasted coffee beans fermented with Pichia kluyveri had around 43% (w/w) higher amount of isoamyl acetate as compared to roasted coffee beans obtained from an identically performed comparative method for the fermentation of coffee berries/beans, which did not comprise the addition of Pichia yeast strain starter culture.

The results of working Example 2 herein demonstrate that the coffee brewed from the roasted coffee beans fermented with 5×10⁷ CFU/g Pichia kluyveri had around 60% (w/w) higher amount of isoamyl acetate as compared to roasted coffee beans obtained from an identically performed comparative method for the fermentation of coffee berries/beans, which did not comprise the addition of Pichia yeast strain starter culture.

The results of working Example 2 herein demonstrate that the coffee brewed from the roasted coffee beans fermented with 1×10⁷ CFU/g Pichia anomala had around 51% (w/w) higher amount of isoamyl acetate as compared to roasted coffee beans obtained from an identically performed comparative method for the fermentation of coffee berries/beans, which did not comprise the addition of Pichia yeast strain starter culture.

As known in the art—isoamyl acetate may be seen as a compound that gives a more fruity flavor/taste. See e.g. Swiegers et al (Australian Journal of Grape and Wine Research 11, 139-173, 2005), where isoamyl acetate is described to give a more fruity flavor/taste in wine.

Without being limited to theory—it is believed that little (if any) prior art references explicit describes measurement of isoamyl acetate in coffee.

However, based on e.g. above discussed Swiegers et al article relating to wine it may be said to be plausible that isoamyl acetate would also give a more fruity flavor/taste in coffee.

Said in other words, based on the herein disclosed novel data use of Pichia kluyveri and/or Pichia anomala may give coffee with increased flavor profile (e.g. increased fruity flavor).

Without being limited to theory—based on the teaching as discussed herein it is believed that there is no significant technical reason to believe that other strains of the Pichia genus (e.g. Pichia caribbica) should not be able to provide a herein relevant increased flavor profile.

Without being limited to theory—it is presently believed that in the prior art it is not explicitly described that one may get coffee with increased isoamyl acetate by fermenting with a microorganism (e.g. Pichia) as described herein.

Accordingly, a first aspect of the present invention relates to a method for the fermentation of coffee berries/beans comprising the steps of:
a) adding to a plant material consisting essentially of coffee berries/beans at least one Pichia yeast strain starter culture, wherein the starter culture comprises from 10⁵ to 10¹⁰ CFU/g of the plant material of the Pichia yeast strain; and
b) fermenting the plant material to obtain fermented coffee material.

As described herein—fermentation with Pichia yeast strain may give increased flavor of the coffee material (e.g. roasted coffee beans) e.g. due to the presence of increased amounts of isoamyl acetate—accordingly, the coffee material (e.g. roasted coffee beans) obtained by use of the method of the first aspect gives a novel coffee material (e.g. roasted coffee beans) as such.

Accordingly, a second aspect of the present invention relates to a fermented coffee material (e.g. roasted coffee beans) obtainable by the method according to the first aspect and/or herein related embodiments thereof.

A third aspect of the invention relates to a method of preparing a coffee-based product comprising providing fermented coffee material (e.g. coffee beans) of the second aspect of the invention and preparing thereof a coffee-based product.

A fourth aspect of the present invention relates to a coffee-based product obtainable by the method according to the third aspect of the invention.

### DETAILED DESCRIPTION OF THE INVENTION

### Definitions

All definitions of herein relevant terms are in accordance of what would be understood by the skilled person in relation to the herein relevant technical context.

The term “plant material” includes anything that is or was live vegetation, in particular plants and any parts thereof.

The term “fermentation” refers generally to any activity or process involving enzymatic decomposition (digestion) of organic materials by microorganisms. The term “fermentation” encompasses both anaerobic and aerobic processes, as well as processes involving a combination or succession of one or more anaerobic and/or aerobic stages. In the present invention, fermentation preferably involves the decomposition (digestion) of plant materials as defined above. “Fermentation” as used herein includes the oxidation of organic compounds.

A “spontaneous fermentation” as used herein is one that employs microorganisms naturally present in and/or unconsciously introduced into the fermented organic material at the start or during fermentation. Accordingly, in the above methods an otherwise spontaneous fermentation may be regulated by addition of at least one microbial strain as defined herein.

A “coffee bean” is a seed of the coffee plant, and is the source for coffee. It is the pit inside the red or purple fruit often referred to as a cherry. Even though they are seeds, they are often referred to as ‘beans’ because of their resemblance to true beans.

Herein may the terms coffee bean and coffee seed be used interchangeably.

The term “coffee-based products” herein refers to products that are prepared using fermented coffee beans. The products intend to refer to the products prepared starting from coffee beans that have been subjected to fermentation as described herein. Coffee-based products can be in a liquid form or in a dry or lyophilized form such as in the form of granules, pellets or a powder. It is evident that an example of a coffee-based product could e.g. be coffee as such. Another example could e.g. be a coffee cake.

The term “coffee berry” is in the art sometimes referred to as coffee cherry and the skilled person understands that in the present context may these terms be used interchangeably—accordingly, herein may the terms coffee cherry (or coffee cherries) and coffee berry (or coffee berries) be used interchangeably.

The term “a plant material consisting essentially of coffee berries/beans” shall herein be understood in accordance of what would be understood by the skilled person in relation to the herein relevant technical context. As understood by the skilled person in the present context—depending on the processing method used for making the coffee (e.g. “wet processing” or “dry processing”) there may be removed more or less flesh/skin of the berries/cherries before start of the actual fermentation process. According to the art and as understood by the skilled person in the present context—this fact may be expressed as there for the herein relevant coffee fermentation process is used a plant material consisting essentially of coffee berries/beans.

The term “starter culture” refers to a composition comprising live microorganisms that are capable of initiating or effecting fermentation of organic material, optionally after being cultivated in a separate starter medium for obtaining a high density culture. Accordingly, in an embodiment, a starter culture of the invention may be a high density culture obtained by propagating a starter culture in a suitable medium.

A starter culture according to the present invention may also contain in addition to microorganisms, buffering agents and growth stimulating nutrients or preservatives or other carriers, such as milk powder or sugars.

### Implementation and Aspects of the Invention

As discussed above—the first aspect of the invention relates to a method for the fermentation of coffee berries/beans comprising the steps of:
a) adding to a plant material consisting essentially of coffee berries/beans at least one Pichia yeast strain starter culture, wherein the starter culture comprises from 10⁵ to 10¹⁰ CFU/g of the plant material of the Pichia yeast strain; and
b) fermenting the plant material to obtain fermented coffee material.

It is well known to make coffee as such.

Herein relevant steps such as e.g. fermenting, drying, washing and roasting of the coffee beans may be performed according to standard known processes for making coffee—such as e.g. by standard known “wet processing” and/or “dry processing” coffee making processes.

Accordingly, herein it is not necessary to describe such standard processes in great details and it may therefore be that such standard processes are not described in great details herein.

Preferably, the starter culture comprises from 10⁵ to 10¹⁰ CFU/g of the plant material of the Pichia yeast strain, more preferably the starter culture comprises from 10⁶ to 10¹⁰ CFU/g of the plant material of the Pichia yeast strain—such as e.g. the starter culture comprises from 10⁶ to 10⁸ CFU/g of the plant material of the Pichia yeast strain.

Preferably, the method as described herein relate to what may be termed commercially relevant large scale production of coffee.

Accordingly, preferably the amount of the plant material of step a) and step b) of the first aspect is at least 100 kg, more preferably the amount of the plant material of step a) and step b) of the first aspect is at least 250 kg.

It is evident that in order to get the herein required from 10⁵ to 10¹⁰ CFU/g of the plant material of the Pichia yeast strain—it is preferred that the added starter culture as such is a high density/concentrated culture.

For instance—if the amount of the plant material of step a) and step b) of the first aspect is 100 kg (=10⁵ g) then one needs to add at least (10⁵ CFU/g of the plant×10⁵ g plant)=10¹⁰ CFU of Pichia yeast strain as such in order to get the at least 10⁵ CFU/g of the plant material of the Pichia yeast strain as required in step a) of the first aspect.

Accordingly, in a preferred embodiment the starter culture comprises from 10⁶ to 10¹³ CFU/g of Pichia yeast strain, such as from 10² to 10¹² CFU/g of Pichia yeast strain or such as from 10⁸ to 10¹¹ CFU/g of Pichia yeast strain.

In a more preferred embodiment the starter culture comprises from 10⁶ to 10¹³ CFU/g of Pichia kluyveri yeast strain, such as from 10² to 10¹² CFU/g of Pichia kluyveri yeast strain or such as from 10⁸ to 10¹¹ CFU/g of Pichia kluyveri yeast strain.

The starter culture may be in frozen, liquid or dried form, including e.g. freeze dried form and spray/fluid bed dried form, or frozen or freeze-dried concentrates.

The starter culture may comprise other microorganism such as e.g. lactic acid bacteria (such as e.g. Lactobacillus and/or Lactococcus strains).

Preferably, step a) is carried out at the start of fermentation.

Preferably, the fermenting of step b) of the first aspect is a fermenting of at least 1 day (such as at least 2 days or at least 6 days), where it is preferred that the fermentation is performed at a temperature from 20° C. to 40° C.

Preferably, the Pichia yeast strain is Pichia kluyveri, Pichia anomala, Pichia caribbica or Pichia guilliermondii—more preferably, the Pichia yeast strain is Pichia anomala or Pichia kluyveri and most preferably, the Pichia yeast strain is Pichia kluyveri.

As shown in Example 2 herein—Ethyl acetate was also measured and it was found that P. kluyveri gave lower amount of ethyl acetate as compared to P. anomala.

As known to the skilled person—ethyl acetate has a solvent like flavor and this may be seen as not preferred for a coffee product. Accordingly, in this respect one may say that P. kluyveri would be preferred over P. anomala.

The Pichia kluyveri strain may be a Pichia kluyveri strain selected from the group consisting of Pichia kluyveri strain PK-KR1 and Pichia kluyveri strain PK-KR2 deposited at the National Measurement Institute, 541-65 Clarke Street, South Melbourne, Victoria 3205, Australia, by University of Auckland, School of Biological Sciences, Auckland 1142, New Zealand, and given the accession numbers V06/022711 and V06/022712, respectively.

The Pichia kluyveri PK-KR1 and PK-KR2 strains were deposited on 24 Aug. 2006 at the National Measurement Institute, 541-65 Clarke Street, South Melbourne, Victoria 3205, Australia, by University of Auckland, School of Biological Sciences, Auckland 1142, New Zealand, and given the accession numbers V06/022711 and V06/022712, respectively, as described in WO 2009/110807 on page 14.

Preferably, the method as described herein further comprises the step of:
c) drying the fermented coffee material of step b) of the first aspect to obtain dried beans.

Preferably, method further comprises the step of:
d) roasting the beans of step c) above to obtain roasted coffee beans.

As discussed above—the results of working Example 1 herein demonstrated that the roasted coffee beans fermented with Pichia kluyveri had around 43% (w/w) higher amount of isoamyl acetate as compared to roasted coffee beans obtained from an identically performed comparative method for the fermentation of coffee berries/beans, which did not comprise the addition of Pichia yeast strain starter culture.

As known in the art—isoamyl acetate may be seen as a compound that gives a more fruity flavor/taste—i.e. use of Pichia kluyveri may give coffee with increased flavor profile (e.g. increased fruity flavor).

Accordingly, in a preferred embodiment the method as described herein is a method wherein the roasted coffee beans have at least 10% (w/w) [such as e.g. at least 20% (w/w) or such as at least 30% (w/w)] higher amount of isoamyl acetate as compared to roasted coffee beans obtained from an identically performed comparative method for the fermentation of coffee berries/beans, which does not comprise the addition of Pichia yeast strain starter culture of step (a) of the method of the first aspect of the present invention.

The term “identically performed comparative method” should be understood as the skilled person would understand it in the present context. As understood by the skilled person—the purpose of the comparative method is to test if addition of Pichia yeast gives increased amounts of isoamyl acetate as compared to not addition of Pichia yeast. Accordingly, the term identically means identical in the sense that in the comparative method is everything identically performed except the not addition of Pichia yeast. For instance, the term identically in relation to the comparative method does not relate to e.g. a comparison between Pichia yeast and e.g. a Saccharomyces yeast.

The level isoamyl acetate and isoamyl alcohol may be determined by head-space gas chromatography couple as set out in Example 1 herein or by any other method known to the skilled person.

An embodiment of the invention relates to a method, wherein the method for the fermentation of coffee berries/beans is made by “wet processing”, wherein the plant material is soaked in water in fermentation step b) of first aspect (i.e. the fermentation with the Pichia yeast strain is done in water).

An embodiment of the invention relates to a method, wherein the method for the fermentation of coffee berries/beans is made by “dry processing”, wherein the plant material spread out in the sun in fermentation step b) of first aspect.

In relation to this “dry processing” embodiment—it may be preferred that the addition of Pichia yeast strain starter culture is done by spraying the culture out over the plant material as spread out in the sun.

As discussed above—Coffea plant is a member of the Rubiaceae family—i.e. the coffee plant material is preferably from a Coffea plant.

Several species of Coffea may be grown for the beans. Coffea arabica accounts for 75-80 percent of the world's coffee production, while Coffea canephora accounts for about 20 percent.

Accordingly, in a preferred embodiment—the coffee plant material is from Coffea Arabica or from Coffea canephora.

As discussed above—an advantage of using Pichia to make coffee as described herein is that one may get increased flavor of the coffee.

Accordingly, preferably the method as described herein is performed in order to get increased flavor of the coffee.

As discussed above—fermentation with Pichia yeast strain may give increased flavor of the coffee material (e.g. roasted coffee beans) e.g. due to the presence of increased amounts of isoamyl acetate—accordingly, the coffee material (e.g. roasted coffee beans) obtained by use of the method of the first aspect gives a novel coffee material (e.g. roasted coffee beans) as such.

Accordingly, a second aspect of the present invention relates to a fermented coffee material (e.g. roasted coffee beans) obtainable by the method according to the first aspect and/or herein related embodiments thereof.

A third aspect of the invention relates to a method of preparing a coffee-based product comprising providing fermented coffee material (e.g. coffee beans) of the second aspect of the invention and preparing thereof a coffee-based product.

It is evident that an example of a coffee-based product could e.g. be coffee as such. Other examples could e.g. be a coffee cake, coffee ice etc.

A fourth aspect of the present invention relates to a coffee-based product obtainable by the method according to the third aspect of the invention.

### EXAMPLES

### Example 1

### Study in Kenya

### Materials and Methods

### Fermentation Set-Up

Wet processing fermentation was made in Kenya.

There was added to around 10 kg plant material consisting essentially of coffee berries/beans a Pichia kluyveri yeast strain starter culture, wherein the starter culture comprises around 10⁶ CFU/g of the plant material of the Pichia yeast strain.

The control experiment was an identically performed comparative method for the fermentation of coffee berries/beans, which did not comprise the addition of Pichia yeast strain starter culture.

Fermenting was for 2 days at a temperature from 20° C. to 40° C.

The fermented coffee material was dried to obtain dried beans and roasted to obtain roasted coffee beans.

### Headspace GC-FID Analysis

Headspace gas chromatography coupled with flame ionization detection (GC-FID) was used for the measurement of isoamyl acetate in the fermentation products.

Before measurement the roasted beans were grounded in a standardized way.

### Results

The result for the Pichia experiment was around 0.07 ppm of isoamyl acetate in the Pichia fermented grounded roasted coffee beans.

The result of the control experiment was around 0.04 ppm of isoamyl acetate in the Pichia fermented grounded roasted coffee beans.

### Conclusion

The result of this example 1 demonstrated that the roasted coffee beans fermented with Pichia kluyveri had around 43% (w/w) higher amount of isoamyl acetate as compared to roasted coffee beans obtained from an identically performed comparative method for the fermentation of coffee berries/beans, which did not comprise the addition of Pichia yeast strain starter culture.

### Example 2

### Study in Brazil

### Materials and Methods

### Fermentation Set-Up

Dry coffee processing fermentation was made in Brazil. Coffee trials were performed on coffee cherries, where Pichia kluyveri and P. anomala starter culture were added at the time of spreading out the coffee cherries to start fermentation. There was added to around 25 kg plant material consisting essentially of coffee berries/beans a Pichia kluyveri yeast strain starter culture, wherein the starter culture was added in three different dosages: 5×10⁶ CFU/g, 1×10⁷ CFU/g, 5×10⁷ CFU/g of the plant material of the Pichia yeast strain.

The P. anomala yeast strain starter culture was added at a dosage of 1×10⁷ CFU/g.

The Pichia kluyveri strain was above discussed PK-KR1 strain.

The control experiment was an identically performed comparative method for the fermentation of coffee berries/beans, which did not comprise the addition of Pichia yeast strain starter culture.

Fermenting was for 25 days at a temperature from 20° C. to 40° C., until beans were dry.

The fermented coffee beans were then roasted to obtain roasted coffee beans.

### Headspace GC-FID Analysis

Headspace gas chromatography coupled with flame ionization detection (GC-FID) was used for the measurement of isoamyl acetate and other flavor compounds in the final coffee, brewed from the roasted coffee beans. Before measurement the roasted beans were grounded and coffee was prepared in a standardized way.

### Results

Isoamyl acetate, hexyl acetate and isoamyl alcohol concentrations were measured in coffee extracts, brewed from the roasted coffee beans (Table 1).

TABLE 1
Isoamyl acetate, hexyl acetate and isoamyl alcohol concentrations in
coffee extracts

| | Isoamyl acetate | Hexyl acetate | Isoamyl alcohol |
|---|---|---|---|
| Sample | (ppm) | (ppm) | (ppm) |
| Control | 0.035 | 0.20 | 0.37 |
| P. anomala 1E7 | 0.053 | 0.26 | 0.47 |
| P. kluyveri 5E6 | 0.047 | 0.25 | 0.47 |
| P. kluyveri 1E7 | 0.049 | 0.27 | 0.46 |
| P. kluyveri 5E7 | 0.056 | 0.27 | 0.51 |

Ethyl acetate was also measured and it was found that P. kluyveri gave a lower amount of ethyl acetate as compared to P. anomala.

### Conclusion

The result of this example 2 demonstrated that the coffee brewed from the roasted coffee beans fermented with 5×10⁷ CFU/g Pichia kluyveri had around 60% (w/w) higher amount of isoamyl acetate as compared to roasted coffee beans obtained from an identically performed comparative method for the fermentation of coffee berries/beans, which did not comprise the addition of Pichia yeast strain starter culture.

The result of this example 2 demonstrated that the coffee brewed from the roasted coffee beans fermented with 1×10⁷ CFU/g Pichia anomala had around 51% (w/w) higher amount of isoamyl acetate as compared to roasted coffee beans obtained from an identically performed comparative method for the fermentation of coffee berries/beans, which did not comprise the addition of Pichia yeast strain starter culture.

Further, the results in this experiment showed a dose effect—i.e. higher amounts of Pichia kluyveri gave higher amounts of isoamyl acetate.

Ethyl acetate was also measured and it was found that P. kluyveri gave a lower amount of ethyl acetate as compared to P. anomala.

As known to the skilled person—ethyl acetate has a solvent like flavor and this may be seen as not preferred for a coffee product. Accordingly, in this respect one may say that P. kluyveri would be preferred over P. anomala.

### REFERENCES

1: Silva et al.: Succession of bacterial and fungal communities during natural coffee (Coffea arabica) fermentation, Food microbiology, vol. 25, December 2008, pages 951-957
2: Wafa Masoud et al: Yeast involved in fermentation of Coffea arabica in East Africa determined by genotyping and by direct denaturating gradient gel electrophoresis, Yeast, vol. 21, May 2004, pages 549-556
3: EP1695631A1 (Suntory Limited)
4: Swiegers et al (Australian Journal of Grape and Wine Research 11, 139-173, 2005)

1.-20. (canceled)

21. A method for the fermentation of coffee berries/beans comprising:
(a) adding to a plant material consisting essentially of coffee berries/beans at least one Pichia yeast strain starter culture in an amount to provide from 10⁵ to 10¹⁰ CFU Pichia yeast per g of the plant material; and
(b) fermenting the plant material to obtain fermented coffee material.

22. The method of claim 21, wherein the starter culture is added in an amount to provide from 10⁶ to 10¹⁰ CFU Pichia yeast per g of the plant material.

23. The method of claim 21, wherein the starter culture is added in an amount to provide from 10⁷ to 10¹² CFU Pichia yeast per g of the plant material.

24. The method of claim 23, wherein the starter culture is added in an amount to provide from 10⁸ to 10¹¹ CFU Pichia yeast per g of the plant material.

25. The method of claim 21, wherein the amount of the plant material is at least 100 kg.

26. The method of claim 21, wherein step (a) is carried out at the start of fermentation.

27. The method of claim 21, wherein the fermenting of step (b) is conducted over at least 1 day at a temperature from 20° C. to 40° C.

28. The method of claim 27, wherein the fermenting of step (b) is conducted over at least 2 days.

29. The method of claim 21, wherein the Pichia yeast strain is selected from the group consisting of Pichia kluyveri, Pichia anomala, Pichia caribbica and Pichia guilliermondii.

30. The method of claim 29, wherein the Pichia yeast strain is selected from the group consisting of Pichia anomala and Pichia kluyveri.

31. The method of claim 29, wherein the Pichia yeast strain is Pichia kluyveri.

32. The method of claim 21, wherein the method further comprises:
(c) drying the fermented coffee material of step (b) to obtain dried beans.

33. The method of claim 32, wherein the method further comprises:
(d) roasting the dried beans of step (c) to obtain roasted coffee beans.

34. The method of claim 33, wherein the roasted coffee beans have an isoamyl acetate content at least 10% (w/w) higher than that of roasted coffee beans obtained by an identically performed comparative method for the fermentation of coffee berries/beans without adding a Pichia yeast strain starter culture in accordance with step (a).

35. The method of claim 21, wherein the fermenting step (b) is conducted in water.

36. The method of claim 21, wherein the plant material is of a species selected from the group consisting of Coffea Arabica and Coffea canephora.

37. The method of claim 21, wherein the method is performed in order to get increased flavor of the coffee.
